(19) United States
(12) Patent Application Publication
(10) Pub. No.: US 2024/0332608 A1
(43) Pub. Date: Oct. 3, 2024

(54) METHOD FOR PREPARING ELECTROLYTE AND BATTERY INCLUDING THE SAME

(71) Applicant: UIF (University Industry Foundation), Yonsei University, Seoul (KR)

(72) Inventors: Yoon Seok JUNG, Seoul (KR); Jehoon WOO, Seoul (KR); Bo Yeong JANG, Jeonbuk-do (KR)

(73) Assignee: UIF (University Industry Foundation), Yonsei University, Seoul (KR)

(21) Appl. No.: 18/621,488

(22) Filed: Mar. 29, 2024

(30) Foreign Application Priority Data
Mar. 30, 2023 (KR) 10-2023-0041890
Mar. 30, 2023 (KR) 10-2023-0041891

(51) Int. Cl. H01M 10/0562

(52) U.S. Cl. CPC H01M 10/0562; H01M 2300/008

(57) ABSTRACT

The present disclosure relates to a method for preparing an electrolyte and a battery including the same. The electrolyte is prepared by drying a precursor solution containing a lithium-based precursor and a sulfide-based or oxide-based precursor to form a precursor powder, and irradiating microwaves thereto with no heat treatment. Therefore, it is possible to obtain the electrolyte through a simple process and to increase the crystallinity of the electrolyte in a short time, while removing residual organic substances, and thus it is possible to prevent a risk of electrical leakage and generation of an internal short-circuit. It is also possible to significantly improve the charge/discharge performance of a solid-state battery.

### CROSS-REFERENCE TO RELATED APPLICATION

This application claims priority to Korean Patent Application Nos. 10-2023-0041890 and 10-2023-0041891 filed on Mar. 30, 2023, and all the benefits accruing therefrom under 35 U.S.C. § 119, the contents of which in its entirety are herein incorporated by reference.

### BACKGROUND

### 1. Field

The present disclosure relates to a method for preparing an electrolyte and a battery including the same.

### 2. Description of the Related Art

The methods for preparing a sulfide-based solid electrolyte may be classified into a solid-phase method including a step requiring mechanical force such as physical mixing or ball milling and a wet method using an organic solvent. The solid-phase method is disadvantageous in that it needs a large amount of energy for pulverizing and blending precursors or raw materials, resulting in a high cost.

In addition, the wet method using an organic solvent includes agitation, evaporation and heat treatment steps, and thus allows easy mixing of precursors or raw materials and requires a relatively short time and low energy consumption as compared to the solid-phase method, and thus is advantageous for mass production of a solid electrolyte.

However, according to the wet method for preparing a sulfide-based solid electrolyte, residual organic substances remain even after a drying step, and thus the residual organic substances are also carbonized, in the case of a sulfide-based solid electrolyte requiring high-temperature heat treatment, thereby forming a carbonized sulfide-based solid electrolyte including impurities. The carbonized solid electrolyte shows a high level of electroconductivity of about 19 mS/cm. In addition, the residual organic substances may generate impurities, such as Li₂S, LiX and Li₃PO₄, during the high-temperature heat treatment.

When using such a carbonized sulfide-based solid electrolyte having high electroconductivity as an electrolyte layer, there are problems of a risk of electrical leakage and generation of an internal short-circuit. In addition, when such a solid electrolyte is used for a Ni-rich cathode material, it shows poor performance and is limited in use.

According to the related art, some studies have been conducted to reduce the amount of the residual organic substances by controlling the organic solvent and to inhibit the electroconductivity. However, it is difficult to remove the residual organic substances completely, although the electroconductivity is partially inhibited. Therefore, such studies cannot provide a fundamental solution. In addition, there has been an attempt to reduce the residual organic substances by controlling the boiling point in the wet method for preparing a sulfide-based solid electrolyte. However, it is not possible to prevent carbonization.

Under these circumstances, there is a need for a novel method for improving the problems of the wet method to increase the crystallinity of a sulfide-based or oxide-based solid electrolyte and to remove the residual organic substances.

### REFERENCES

### Patent Documents

(Patent Document 1) Korean Patent Laid-Open No. 2018-0055086

### SUMMARY

The present disclosure is directed to providing a method for preparing an electrolyte which allows removal of residual organic substances while increasing the crystallinity of the electrolyte.

The present disclosure is also directed to providing an electrolyte.

In addition, the present disclosure is directed to providing a solid-state battery including the electrolyte according to the present disclosure.

In addition, the present disclosure is directed to providing a device including the solid-state battery according to the present disclosure.

Further, the present disclosure is directed to providing an electric device including the solid-state battery according to the present disclosure.

In one aspect of the present disclosure, there is provided a method for preparing an electrolyte, including the steps of:
preparing a precursor solution containing a lithium-based precursor, and a sulfide-based or oxide-based precursor; drying the precursor solution to obtain a precursor powder; and irradiating microwaves to the precursor powder to obtain an electrolyte represented by the following Chemical Formula 1:

LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

In another aspect of the present disclosure, there is provided an electrolyte represented by the following Chemical Formula 1 and obtained by irradiating microwaves to precursor powder formed by drying a precursor solution containing a lithium-based precursor, and a sulfide-based or oxide-based precursor:

LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

In still another aspect of the present disclosure, there is provided a solid-state battery including the electrolyte according to the present disclosure.

In still another aspect of the present disclosure, there is provided a device which includes the solid-state battery according to the present disclosure and is any one selected from communication devices, transport devices and energy storage devices.

In yet another aspect, there is provided an electric device which includes the solid-state battery according to the present disclosure and is any one selected from electric vehicles, hybrid electric vehicles, plug-in hybrid electric vehicles and electric power storage devices.

The electrolyte according to the present disclosure is prepared by drying a precursor solution containing a lithium-based precursor and a sulfide-based or oxide-based precursor to form a precursor powder, and then irradiating microwaves thereto with no heat treatment. Therefore, it is possible to obtain the electrolyte through a simple process and to increase the crystallinity of the electrolyte in a short time, while removing residual organic substances, and thus it is possible to prevent a risk of electrical leakage and generation of an internal short-circuit. It is also possible to significantly improve the charge/discharge performance of a solid-state battery.

In addition, the electrolyte according to the present disclosure is obtained by irradiating microwaves after supporting the precursor powder in carbon or a carbon composite, and thus it is possible to inhibit carbonization through the heat treatment at high temperature for a short time and to remove residual organic substances, thereby preventing a risk of electrical leakage and generation of an internal short circuit by virtue of the low electroconductivity. Further, it is possible to significantly improve the charge/discharge performance of a solid-state battery.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a schematic flow chart illustrating the method for preparing an electrolyte according to the present disclosure.

FIG. 2 is a graph illustrating the results of X-ray diffractometry (XRD) of the electrolyte (Li₆PS₅I) prepared according to each of Example 1-1 and Comparative Examples 1-1 to 1-7.

FIG. 3 is a graph illustrating the electroconductivity of the electrolyte (Li₆PS₅I) prepared according to each of Example 1-1 and Comparative Examples 1-1 to 1-7 depending on temperature.

FIG. 4 is a photographic image illustrating a change in color of the electrolyte (Li₆PS₅I) prepared according to each of Example 1-1 and Comparative Examples 1-2 to 1-7 depending on microwave irradiation and heat treatment.

FIG. 5A and FIG. 5B are graphs illustrating the charge/discharge performance (FIG. 5A) and rate characteristics (FIG. 5B) of the solid-state battery obtained by using the electrolyte prepared according to each of Example 1-1 (blue line) and Comparative Example 1-1 (black line).

FIG. 6 is a graph illustrating the results of X-ray diffractometry (XRD) of the electrolyte (Li₆PS₅Cl) prepared according to each of Example 2-1 and Comparative Examples 2-1 to 2-3.

FIG. 7 shows the Nyquist plot, direct current (DC) polarization curve and linear regression graph of the electrolyte (Li₆PS₅Cl) prepared according to each of Example 2-1 and Comparative Examples 2-1 and 2-2.

FIG. 8 is a photographic image illustrating a change in color of the electrolyte (Li₆PS₅Cl) prepared according to Example 2-1 as compared to Comparative Examples 2-1 and 2-2.

FIG. 9A and FIG. 9B are graphs illustrating the charge/discharge performance (FIG. 9A) and rate characteristics (FIG. 9B) of the solid-state battery obtained by using the electrolyte prepared according to each of Example 2-1 (blue line) and Comparative Example 2-1 (light green line).

FIG. 10 is a graph illustrating the results of elemental analysis of the solid state battery using the electrolyte prepared according to each of Example 2-1 and Comparative Example 2-1.

FIG. 11 is a graph illustrating the results of Raman analysis of the solid state battery using the electrolyte prepared according to each of Example 2-1 and Comparative Example 2-1.

FIG. 12 is a graph illustrating the results of ³¹P nuclear magnetic resonance (NMR) analysis of the solid state battery using the electrolyte prepared according to each of Example 2-1 and Comparative Example 2-1.

### DETAILED DESCRIPTION

Hereinafter, the present disclosure will be explained in detail with reference to a specific embodiment.

The present disclosure relates to a method for preparing an electrolyte and a battery including the same.

As described above, in the case of a sulfide-based or oxide-based solid electrolyte using the wet method according to the related art, since residual organic substances remain after a drying step, and the residual organic substances are also carbonized through heat treatment, the electrolyte is prepared in a carbonized state containing impurities and shows high electroconductivity. When using such a carbonized sulfide-based or oxide-based solid electrolyte having high electroconductivity as an electrolyte layer, there are problems of a risk of electrical leakage and generation of an internal short-circuit.

Under these circumstances, the electrolyte according to the present disclosure is prepared by drying a precursor solution containing a lithium-based precursor and a sulfide-based or oxide-based precursor to form a precursor powder, and then irradiating microwaves thereto with no heat treatment. Therefore, it is possible to obtain the electrolyte through a simple process and to increase the crystallinity of the electrolyte in a short time, while removing residual organic substances, and thus it is possible to prevent a risk of electrical leakage and generation of an internal short-circuit. It is also possible to significantly improve the charge/discharge performance of a solid-state battery.

Particularly, in one aspect of the present disclosure, there is provided a method for preparing an electrolyte, including the steps of:

(A) preparing a precursor solution containing a lithium-based precursor, and a sulfide-based or oxide-based precursor; (B) drying the precursor solution to obtain a precursor powder; and (C) irradiating microwaves to the precursor powder to obtain an electrolyte represented by the following Chemical Formula 1:

LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

The method for preparing an electrolyte according to the present disclosure may be carried out in two different modes depending on whether a step of supporting in carbon is used or not.

In the first mode, the microwave irradiation in step (C) is carried out directly to the precursor powder, while not supporting the precursor powder obtained from step (B) in carbon or a carbon composite.

Herein, in the step of preparing an electrolyte, microwaves are irradiated preferably at an output of 500-900 W for 10⁻³⁰ minutes.

In addition, X preferably represents I. The reason is as follows. If X represents Cl or Br, it is essentially required to control the process in order to prevent thermal runaway when microwaves are irradiated directly to the precursor powder without supporting the precursor in carbon or a carbon composite. On the contrary, if X represents I, it is shown that no thermal runaway or possibility of explosion caused thereby is observed even without controlling the process separately. For these reasons, when microwaves are irradiated directly to the precursor powder without supporting the precursor powder in carbon or a carbon composite, X is preferably I, not Br or Cl.

In the second mode, the microwave irradiation in step (C) is carried out after supporting the precursor powder obtained from step (B) in carbon or a carbon composite.

Herein, in the step of preparing an electrolyte, microwaves are irradiated preferably at an output of 50-1,000 W for 30 seconds to 10 minutes.

In addition, X preferably represents Cl. This is because there is a significant advantage if X represents CI as compared to I or Br, when irradiating microwaves after supporting the precursor powder in carbon or carbon composite. This is based on the fact that the electrolyte shows significantly increased crystallinity if X is Cl as compared to I or Br, when irradiating microwaves after supporting the precursor powder in carbon or carbon composite. In addition, it is shown that such a significant increase in crystallinity greatly contributes to an increase in electroconductivity or lithium-ion conductivity and long-term cell stability.

Hereinafter, the mode including no step of supporting in carbon will be explained first, and then the mode including a step of supporting in carbon will be explained in turn.

First, the mode including no step of supporting in carbon will be explained.

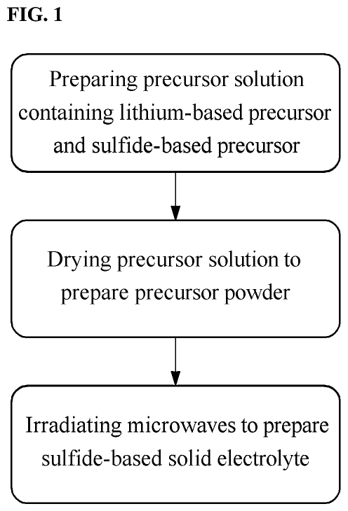

FIG. 1 is a schematic flow chart illustrating the method for preparing an electrolyte according to the present disclosure.

The step of preparing a precursor solution may be carried out by mixing a lithium-based precursor, and a sulfide-based or oxide-based precursor in an organic solvent.

The organic solvent does not react with the electrolyte, and particular examples thereof may include at least one selected from the group consisting of tetrahydrofuran, acetonitrile, ethyl propionate, ethyl acetate, dimethyl carbonate, N-methylformamide, 1,2-dimethoxyethane, ethanol and methanol, but are not limited thereof.

Preferably, the organic solvent may be at least one selected from the group consisting of ethanol, methanol and tetrahydrofuran, and ethanol or tetrahydrofuran is most preferred.

The lithium-based precursor may be at least one selected from the group consisting of LiCl, LiBr, LiI and Li₂S or may be at least one selected from the group consisting of LiCl, LiI and Li₂S, and a mixture of Li₂S with LiI is preferred.

The mixture of Li₂S with LiI may be a mixture containing Li₂S and LiI mixed at a molar ratio of 1:3. Most preferably, the mixture of Li₂S with LiI may be a mixture containing Li₂S and LiI mixed at a molar ratio of 1:1-1:2.

The sulfide-based precursor may be at least one selected from the group consisting of Li₂S, P₂S₅, FeS, MoS₂, SnS₂, SnS, GeS₂, GeS, Al₂S₃, Sb₂S₃, Ga₂S₃ TiS₂, B₂S₃ and SiS₂, Li₂S, P₂S₅ or a mixture thereof may be preferred, and a mixture of Li₂S with P₂S₅ may be most preferred.

The oxide-based precursor may be at least one selected from the group consisting of Li₂O, P₂O₅, ZnO, SnO₂, Sb₂O₃, Sb₂O₅, Fe₂O₃, Fe₂O₄, Bi₂O₃ and In₂O₃, Li₂O, P₂O₅ or a mixture thereof may be preferred, and a mixture of Li₂O with P₂O₅ may be most preferred.

The mixture of Li₂S with P₂S₅ may be a mixture containing Li₂S and P₂S₅ mixed at a molar ratio of 2:1-4:1, preferably 2.5:1-3.5:1. Herein, when Li₂S is used at a molar ratio of less than 2, lithium-ion conductivity may be degraded. On the other hand, when the molar ratio of Li₂S is larger than 4, Li₂S may remain unreacted and may function as impurity.

The precursor solution may include the lithium-based precursor and the sulfide-based or oxide-based precursor mixed at a molar ratio of 1:0.3-1:2.5, preferably 1:0.5-1:2, more preferably 1:0.7-1:1.5, and most preferably 1:0.9-1:1.3. Herein, when the sulfide-based or oxide-based precursor is used at a molar ratio of less than 0.3, the electrolyte represented by Chemical Formula 1 cannot be formed sufficiently. On the other hand, when the sulfide-based or oxide-based precursor is used at a molar ratio of larger than 2.5, an electrolyte other than the electrolyte represented by Chemical Formula 1 may coexist due to the unreacted sulfide-based or oxide-based precursor.

The step of preparing a precursor solution may be carried out by mixing the lithium-based precursor with the sulfide-based or oxide-based precursor at room temperature for 9-15 hours, preferably 10-14 hours, most preferably 11-13 hours.

In the step of preparing a precursor powder, the drying may be carried out at 150-250° C. for 4-15 hours, preferably at 180-230° C. for 5-13 hours, and most preferably at 190-210° C. for 6-12 hours. Herein, when both the drying temperature condition and drying time condition are not satisfied in preparing the precursor powder, the precursor powder cannot be dried sufficiently or requires a long drying time, resulting in an increase in processing cost.

In the step of preparing an electrolyte, microwave irradiation may be carried out at an output of 500-900 W for 10⁻³⁰ minutes, preferably at an output of 580-820 W for 11-25 minutes, more preferably at an output of 610-790 W for 13-20 minutes, and most preferably at an output of 650-750 W for 14-17 minutes. Herein, when the microwave irradiation is carried out at an output of less than 500 W, or for a time of less than 10 minutes, the resultant electrolyte shows poor crystallinity, or the residual organic substances are not removed sufficiently, resulting in degradation of lithium-ion conductivity. On the other hand, when the microwave irradiation is carried out at an output of more than 900 W, or for a time of more than 30 minutes, the residual organic substances may be carbonized.

Particular examples of the electrolyte represented by Chemical Formula 1 may include at least one selected from the group consisting of Li₆PS₅Cl, Li₆PS₅Br and Li₆PS₅I, preferably Li₆PS₅Cl or Li₆PS₅I, and most preferably Li₆PS₅I.

The electrolyte may show a lithium-ion conductivity of 2.0×10−6 to 3.5×10⁻³ S/cm, preferably 2.5×10⁻⁶ to 1.0×10⁻⁴ S/cm, and most preferably 6.0×10⁻⁶ to 1.0×10⁻⁵ S/cm at 30° C.

The sulfide-based or oxide-based solid electrolyte prepared through the wet process according to the related art shows increased electroconductivity due to the carbonization of residual organic substances, and thus is problematic in that it causes a risk of electrical leakage and generation of an internal short-circuit when being used as an electrolyte layer. However, since the electrolyte according to the present disclosure not only has high lithium-ion conductivity but also shows significantly low electroconductivity, it is possible to prevent a risk of electrical leakage and generation of an internal short-circuit.

Particularly, although it is not clearly described in the following Examples and Comparative Examples, a solid-state battery was manufactured through the conventional method by applying the electrolyte obtained by varying the following eight conditions in the method for preparing an electrolyte according to the present disclosure to the cathode. Then, the solid-state battery was charged and discharged 500 times, and side reactions between the cathode active material and the electrolyte, interfacial resistance, electrode stability and lithium-ion conductivity were evaluated.

As a result, unlike the other conditions and numerical ranges, it is shown that when all of the following eight conditions are satisfied, side-reactions between the cathode active material and the electrolyte occur little in the electrode, interfacial resistance is significantly low, high lithium-ion conductivity is realized, and the battery shows improved charge/discharge performance. Particularly, it is shown that when using Li₆PS₅I as an electrolyte, there is no possibility of explosion of the electrode caused by thermal runaway even without controlling the processing conditions specifically, and thus the electrode has significantly high stability.
1) the lithium-based precursor is a mixture containing Li₂S and LiI mixed at a molar ratio of 1:1-1:3; 2) the sulfide-based precursor is a mixture containing Li₂S and P₂S₅ mixed at a molar ratio of 2:1-4:1; 3) the precursor solution includes the lithium-based precursor and the sulfide-based or oxide-based precursor mixed at a molar ratio of 1:0.9-1:1.3; 4) the step of preparing a precursor solution is carried out by mixing the precursors at room temperature for 11-13 hours; 5) the drying is carried out at 190-210° C. for 6-12 hours in the step of preparing a precursor powder; 6) microwaves are irradiated at an output of 650-750 W for 14-17 minutes in the step of preparing an electrolyte; 7) the electrolyte is Li₆PS₅I; and 8) the electrolyte shows a lithium-ion conductivity of 6.0×10⁻⁶ to 1.0×10⁻⁵ S/cm at 30° C.

However, if any one of the above eight conditions is not satisfied, side reactions occur undesirably between the cathode active material and the electrolyte in the electrode, after the 250th charge/discharge cycle, depending on the operating condition of the battery. Particularly, cracks may be generated due to the interfacial resistance, the electrolyte may be lost partially, and lithium-ion conductivity may not meet an expected level. In addition, the electrode may explode due to thermal runaway, resulting in poor electrode stability undesirably.

In another aspect of the present disclosure, there is provided an electrolyte represented by the following Chemical Formula 1 and obtained by irradiating microwaves directly to a precursor powder formed by drying a precursor solution containing a lithium-based precursor, and a sulfide-based or oxide-based precursor, while not supporting the precursor powder in carbon or a carbon composite:

LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

In still another aspect of the present disclosure, there is provided a solid-state battery including the electrolyte according to the present disclosure.

The solid-state battery includes a solid electrolyte membrane, a cathode, an anode and a separator, wherein the electrolyte is contained in at least one of the cathode, the anode and the separator.

In still another aspect of the present disclosure, there is provided a device which includes the solid-state battery according to the present disclosure and is any one selected from communication devices, transport devices and energy storage devices.

In yet another aspect, there is provided an electric device which includes the solid-state battery according to the present disclosure and is any one selected from electric vehicles, hybrid electric vehicles, plug-in hybrid electric vehicles and electric power storage devices.

Next, the mode including a step of supporting in carbon will be explained. However, the contents overlapped with the mode including no step of supporting in carbon will be omitted hereinafter, and the following description is centering on the contents different from or added to the overlapped contents.

In this mode, carbothermal shock is used, wherein the carbothermal shock refers to a method including supporting a solid electrolyte in carbon or a carbon composite by using the property of the carbon or carbon composite having a high dielectric loss constant that it reaches to high temperature in an instant upon the exposure to microwaves and is cooled rapidly, and carrying out heat treatment at high temperature for a short time.

In the step of preparing an electrolyte, a carbothermal shock method may be carried out by supporting the precursor powder in carbon or a carbon composite and irradiating microwaves thereto. The carbon or carbon composite is characterized in that it generates heat when absorbing microwaves. According to the present disclosure, the above characteristic is used. Thus, when microwaves are irradiated to the precursor powder supported in carbon or a carbon composite, the carbon or carbon composite absorbs microwaves and carbon around the solid electrolyte reaches to high temperature rapidly and is cooled rapidly to realize an effect like tempering and to improve the crystallinity of the electrolyte. Therefore, there is an advantage in that heat treatment is carried out at high temperature for a short time to improve the crystallinity and to provide the effects of removing residual organic substances and inhibiting formation of impurities.

The carbon composite may be a material showing excellent dielectric loss property upon the irradiation of microwaves. Particular examples of the carbon composite may include at least one selected from the group consisting of carbon black, graphite and SiC, preferably carbon black, graphite or a mixture thereof, and most preferably carbon black. Herein, ‘dielectric loss’ refers to a process including absorbing a significant amount of excitation energy at a specific frequency and transferring it in the form of heat energy, and the energy consumed by dielectric loss characteristically heats the corresponding dielectric material.

The carbon or carbon composite may be used in an amount of 100-220 wt %, preferably 120-200 wt %, and most preferably 155-175 wt %, based on 100 wt % of the precursor powder. Herein, when the carbon or carbon composite is used in an amount of less than 100 wt %, the electrolyte may require an excessively long crystal growth time, or formation of sufficient crystallinity may be difficult. On the other hand, when the carbon or carbon composite is used in an amount of larger than 220 wt %, the electrolyte may cause excessive crystal growth due to a high surrounding temperature to cause formation of impurities or excessive deformation, and may be carbonized partially, thereby making it difficult to apply the electrolyte to an electrolyte layer or electrode layer.

The microwave irradiation is carried out preferably at an output of 50-1,000 W for 30 seconds to 10 minutes, preferably at an output of 80-900 W for 1-8 minutes, more preferably at an output of 100-700 W for 2-7 minutes, and most preferably at an output of 180-700 W for 3-5 minutes. Herein, when the irradiation output of microwaves is less than 50 W, or when the irradiation time is less than 30 seconds, the resultant electrolyte shows poor crystallinity, and the residual organic substances cannot be removed sufficiently, resulting in low lithium-ion conductivity. On the other hand, when the irradiation output is higher than 1000 W, or when the irradiation time is larger than 10 minutes, the residual organic substances may be carbonized.

Particular examples of the electrolyte represented by Chemical Formula 1 may include at least one selected from the group consisting of Li₆PS₅Cl, Li₆PS₅Br and Li₆PS₅I, preferably Li₆PS₅Cl or Li₆PS₅I, and most preferably Li₆PS₅Cl.

The electrolyte may show a lithium-ion conductivity of 1.9-5 mS/cm and an electroconductivity of 5×10⁻¹⁰ to 1×10⁻⁶ S/cm at 30° C., preferably a lithium-ion conductivity of 2.0-4 mS/cm and an electroconductivity of 1×10⁻⁹ to 2×10⁻⁷ S/cm at 30° C., and most preferably a lithium-ion conductivity of 2.1-3.2 mS/cm and an electroconductivity of 1×10⁻⁹ to 3×10⁻⁹ S/cm at 30° C.

The sulfide-based solid electrolyte prepared through the wet process according to the related art shows increased electroconductivity due to the carbonization of residual organic substances, and thus is problematic in that it causes a risk of electrical leakage and generation of an internal short-circuit when being used as an electrolyte layer. However, since the electrolyte according to the present disclosure not only has high lithium-ion conductivity but also shows significantly low electroconductivity, it is possible to prevent a risk of electrical leakage and generation of an internal short-circuit.

The content of sulfur in the electrolyte may be 48-70 wt %, preferably 51-65 wt %, more preferably 53-62 wt %, and most preferably 55-60 wt %, based on 100 wt % of the electrolyte.

According to the results of Raman analysis of the electrolyte, the ratio (I_{D}/I_{P}) of D-band intensity (I_{D}) to PS₄³⁻ peak intensity may be 0.5-0.7, and the ratio (I_{G}/I_{P}) of G-band intensity (I_{G}) to PS₄³⁻ peak intensity may be 0.4-0.8.

As determined by ³¹P NMR analysis, the electrolyte may show a ratio of Li₃PO₄ impurity peak intensity to PS₄³⁻ peak intensity of 0.1-0.5, preferably 0.2-0.4, and most preferably 0.2-0.3.

Particularly, although it is not clearly described in the following Examples and Comparative Examples, a solid-state battery was manufactured through the conventional method by applying the electrolyte obtained by varying the following fourteen conditions in the method for preparing an electrolyte according to the present disclosure to the cathode. Then, the solid-state battery was charged and discharged 500 times, and the chemical stability, charge density and electrode stability were evaluated.

As a result, unlike the other conditions and numerical ranges, it is shown that when all of the following fourteen conditions are satisfied, high charge density between the cathode active material and the electrolyte is provided to prevent destruction of the composition caused by lithium evaporation, and excellent chemical stability and electrode stability are realized. Particularly, it is shown that when using Li₆PS₅Cl or Li₆PS₅I as an electrolyte, there is no possibility of explosion of the electrode caused by thermal runaway even without controlling the processing conditions specifically, and thus the electrode has significantly high stability.
1) The lithium-based precursor is a mixture containing Li₂S and LiCl or LiI mixed at a molar ratio of 1:1-1:3; 2) the sulfide-based precursor is a mixture containing Li₂S and P₂S₅ mixed at a molar ratio of 2:1-4:1; 3) the step of preparing a precursor solution is carried out by mixing the precursors at room temperature for 11-13 hours; 4) the precursor powder includes the lithium-based precursor and the sulfide-based precursor mixed at a molar ratio of 1:0.7-1:1.5; 5) the drying is carried out at 190-210° C. for 6-12 hours in the step of preparing a precursor powder; 6) the step of preparing an electrolyte is carried out by supporting the precursor powder in carbon or a carbon composite and irradiating microwaves thereto; 7) the carbon composite is carbon black; 8) the carbon or carbon composite is used in an amount of 155-175 wt % based on 100 wt % of the precursor powder; 9) the microwave irradiation is carried out at an output of 100-700 W for 2-7 minutes; 10) the electrolyte is Li₆PS₅Cl or Li₆PS₅I; 11) the electrolyte shows a lithium-ion conductivity of 2.1-4 S/cm and an electroconductivity of 1×10⁻⁹ to 2×10⁻⁷ S/cm at 30° C.; 12) the content of sulfur in the electrolyte is 53-62 wt % based on 100 wt % of the electrolyte; 13) the ratio (I_{D}/I_{P}) of D-band intensity (I_{D}) to PS₄³⁻ peak intensity is 0.5-0.7, and the ratio (I_{G}/I_{P}) of G-band intensity (I_{G}) to PS₄³⁻ peak intensity is 0.4-0.8, according to the results of Raman analysis of the electrolyte; and 14) the electrolyte shows a ratio of Li₃PO₄ impurity peak intensity to PS₄³⁻ peak intensity of 0.2-0.4, as determined by ³¹P NMR analysis.

However, if any one of the above fourteen conditions is not satisfied, the charge density between the cathode active material and the electrolyte in the electrode may be decreased and side reactions may occur undesirably, after the 150th charge/discharge cycle, depending on the operating condition of the battery.

More particularly, although it is not clearly described in the following Examples and Comparative Examples, a solid-state battery was manufactured by applying the electrolyte obtained by further satisfying the following eight conditions of the above-described fourteen conditions in the method for preparing an electrolyte according to the present disclosure to the cathode.

Particularly, when applying Li₆PS₅Cl as an electrolyte to the solid-state battery, frictional heat between microwaves and polar molecules is further increased, and thus ingredients having low conductivity form crystallinity better, thereby significantly increasing the density of the electrolyte. By virtue of this, no interfacial resistance and side reactions occur between the cathode active material and the electrolyte, and thus the electrode can be retained as it is without cracking or loss even after repeating charge/discharge cycles.
1) The lithium-based precursor is a mixture containing Li₂S and LiI mixed at a molar ratio of 1:1-1:2; 2) the sulfide-based precursor is a mixture containing Li₂S and P₂S₅ mixed at a molar ratio of 2.5:1-3.5:1; 3) the precursor powder includes the lithium-based precursor and the sulfide-based precursor mixed at a molar ratio of 1:0.9-1:1.3; 4) the microwave irradiation is carried out at an output of 180-700 W for 3-5 minutes; 5) the electrolyte is Li₆PS₅Cl; 6) the electrolyte shows a lithium-ion conductivity of 2.1-3.2 S/cm and an electroconductivity of 1×10⁻⁹ to 3×10⁻⁹ S/cm at 30° C.; 7) the content of sulfur in the electrolyte is 55-60 wt % based on 100 wt % of the electrolyte; and 8) the electrolyte shows a ratio of Li₃PO₄ impurity peak intensity to PS₄³⁻ peak intensity of 0.2-0.3, as determined by ³¹P NMR analysis.

However, if any one of the above eight conditions is not satisfied, the density of the electrolyte is low depending on the operating condition of the battery, and thus cracking or partial loss may occur after repeating charge/discharge cycles, and interfacial resistance and side reactions may occur between the cathode active material and the electrolyte to cause rapid degradation of charge/discharge performance undesirably.

In still another aspect of the present disclosure, there is provided an electrolyte represented by the following Chemical Formula 1 and obtained by supporting a precursor powder formed by drying a precursor solution containing a lithium-based precursor, and a sulfide-based or oxide-based precursor in carbon or a carbon composite, and then irradiating microwaves thereto:

LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

The carbon composite may be at least one selected from the group consisting of carbon black, graphite and SiC, preferably carbon black, graphite or a mixture thereof, and most preferably carbon black.

Particular examples of the electrolyte represented by Chemical Formula 1 may include at least one selected from the group consisting of Li₆PS₅Cl, Li₆PS₅Br and Li₆PS₅I, preferably Li₆PS₅Cl or Li₆PS₅I, and most preferably Li₆PS₅Cl.

The electrolyte may show a lithium-ion conductivity of 1.9-5 mS/cm and an electroconductivity of 5×10⁻¹⁰ to 1×10⁻⁶ S/cm at 30° C., preferably a lithium-ion conductivity of 2.0-4 mS/cm and an electroconductivity of 1×10⁻⁹ to 2×10⁻⁷ S/cm at 30° C., and most preferably a lithium-ion conductivity of 2.1-3.2 mS/cm and an electroconductivity of 1×10⁻⁹ to 3×10⁻⁹ S/cm at 30° C.

The content of sulfur in the electrolyte may be 48-70 wt %, preferably 51-65 wt %, more preferably 53-62 wt %, and most preferably 55-60 wt %, based on 100 wt % of the electrolyte.

According to the results of Raman analysis of the electrolyte, the ratio (I_{D}/I_{P}) of D-band intensity (I_{D}) to PS₄³⁻ peak intensity may be 0.5-0.7, and the ratio (I_{G}/I_{P}) of G-band intensity (I_{G}) to PS₄³⁻ peak intensity may be 0.4-0.8.

As determined by ³¹P NMR analysis, the electrolyte may show a ratio of Li₃PO₄ impurity peak intensity to PS₄³⁻ peak intensity of 0.1-0.5, preferably 0.2-0.4, and most preferably 0.2-0.3.

In still another aspect of the present disclosure, there is provided a solid-state battery including the electrolyte according to the present disclosure.

In still another aspect of the present disclosure, there is provided a device which includes the solid-state battery according to the present disclosure and is any one selected from communication devices, transport devices and energy storage devices.

In yet another aspect, there is provided an electric device which includes the solid-state battery according to the present disclosure and is any one selected from electric vehicles, hybrid electric vehicles, plug-in hybrid electric vehicles and electric power storage devices.

Hereinafter, the present disclosure will be explained in more detail with reference to Examples, but the scope of the present disclosure is not limited thereto.

### Example 1

### Example 1-1: Preparation of Electrolyte (Li₆PS₅I)

First, Li₂S and LiI as lithium-based precursors were introduced to ethanol at a molar ratio of 2:2 and mixed at room temperature for 3 hours to prepare a lithium-based precursor solution. In addition, Li₂S and P₂S₅ as sulfide-based precursors were introduced to tetrahydrofuran as a solvent at a molar ratio of 3:1 and mixed at room temperature for 12 hours to prepare a sulfide-based precursor solution.

Next, a precursor solution containing the lithium-based precursor powder and the sulfide-based precursor powder mixed at a molar ratio of 1:1 was prepared and mixed at room temperature for 12 hours to obtain a precursor solution. Then, the precursor solution was dried at 200° C. for 6 hours to obtain a precursor powder. After that, microwaves were irradiated to the resultant precursor powder at an output of 700 W for 15 minutes to obtain an electrolyte having a structure of Li₆PS₅I.

### Comparative Example 1-1: Preparation of Electrolyte (Li₆PS₅I)

The same procedure as Example 1-1 was carried out, except that microwave irradiation was not carried out, and that the solvent was allowed to evaporate from the precursor solution at 200° C. for 6 hours to obtain an electrolyte having a structure of Li₆PS₅I.

### Comparative Examples 1-2 to 1-7: Preparation of Electrolyte (Li₆PS₅I)

The same procedure as Example 1-1 was carried out, except that microwave irradiation was not carried out, and that the precursor solution was heat treated at a temperature of 300° C. (Comparative Example 1-2), 350° C. (Comparative Example 1-3), 400° C. (Comparative Example 1-4), 450° C. (Comparative Example 1-5), 500° C. (Comparative Example 1-6) and 550° C. (Comparative Example 1-7), respectively, for 6 hours to obtain an electrolyte having a structure of Li₆PS₅I.

### Test Example 1-1: X-Ray Diffractometry (XRD) of Electrolyte (Li₆PS₅I)

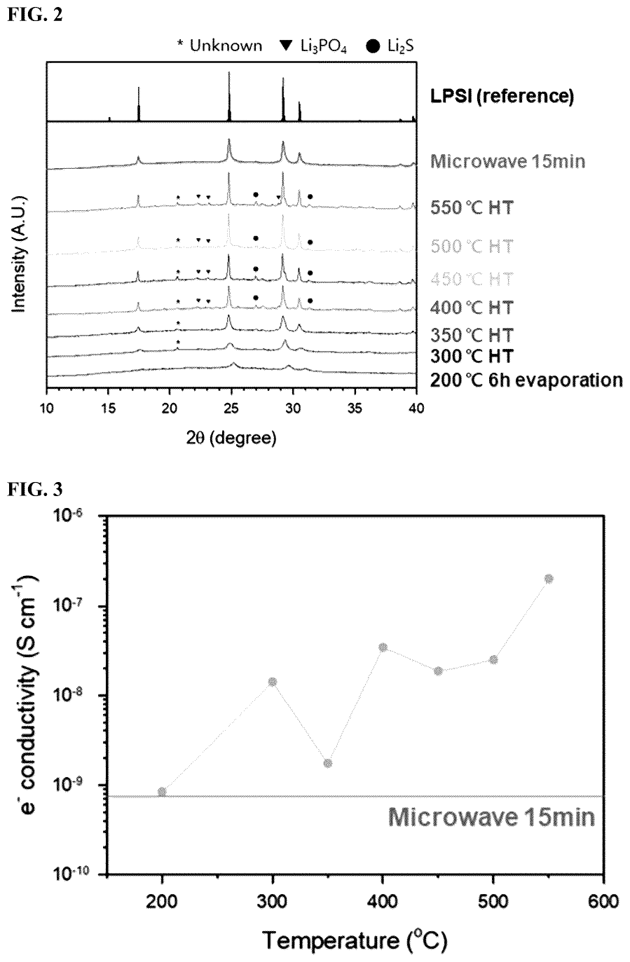

The electrolyte prepared according to each of Example 1-1 and Comparative Examples 1-1 to 1-7 was analyzed by XRD to determine whether residual organic substances were formed or not depending on microwave irradiation and heat treatment. The results are shown in FIG. 2.

FIG. 2 is a graph illustrating the results of XRD of the electrolyte (Li₆PS₅I) prepared according to each of Example 1-1 and Comparative Examples 1-1 to 1-7. Referring to FIG. 2, it can be seen that no residual organic substances are observed and the same peaks as LPSI-based solid electrolyte are shown in Example 1-1 in which microwave irradiation is carried out without heat treatment.

On the other hand, in the case of Comparative Example 1-1 in which the precursor solution is dried without microwave irradiation, peaks appear little, which suggests that LPSI-based solid electrolyte is not formed properly. In addition, in the case of Comparative Examples 1-2 to 1-7 in which the precursor solution is heat treated without microwave irradiation, it can be seen that residual organic substances are formed.

### Test Example 1-2: Electroconductivity Analysis of Electrolyte (Li₆PS₅I)

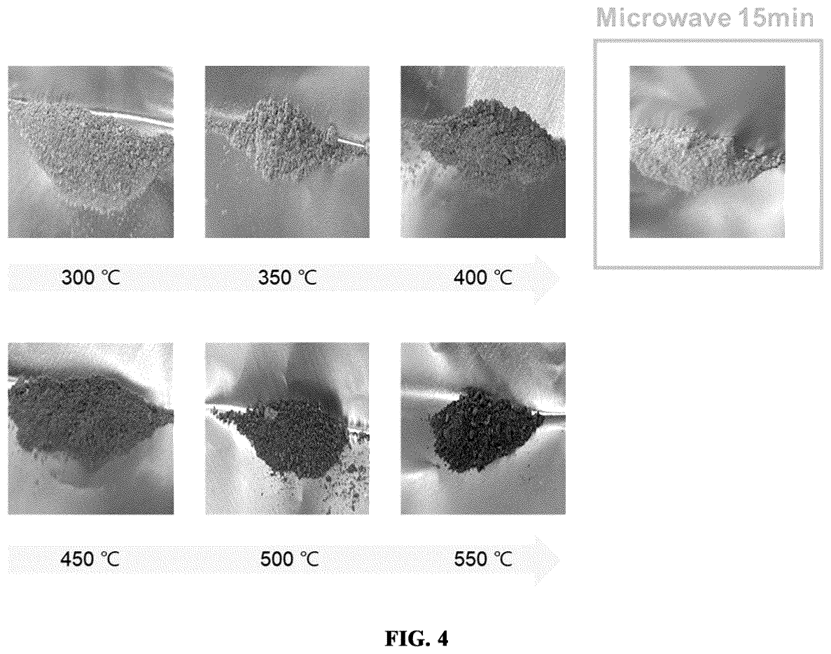

The electrolyte prepared according to each of Example 1-1 and Comparative Examples 1-1 to 1-7 was determined in terms of electroconductivity depending on temperature. The results are shown in FIG. 3.

FIG. 3 is a graph illustrating the electroconductivity of the electrolyte (Li₆PS₅I) prepared according to each of Example 1-1 and Comparative Examples 1-1 to 1-7 depending on temperature. Referring to FIG. 3, Example 1-1 in which microwave irradiation is carried out shows little change in electroconductivity as compared to the electroconductivity before microwave irradiation. On the contrary, in the case of Comparative Examples 1-1 to 1-7, the electroconductivity tends to increase as the temperature increases.

### Test Example 1-3: Quantitative Analysis of Residual Organic Substances of Electrolyte (Li₆PS₅I)

Elemental analysis was carried out to quantitatively analyze the residual organic substances of the electrolyte prepared according to each of Example 1-1 and Comparative Example 1-1. The results are shown in the following Table 1.

TABLE 1

| | | Carbon | Hydrogen |
|---|---|---|---|
| | | (wt %) | (wt %) |
| Comp. Ex. 1-1 | Drying at 200° C. | 2.4 | 0.77 |
| Ex. 1-1 | Drying at 200° C. + Microwave | 1.3 | 0.36 |
| | irradiation for 15 minutes | | |

Referring to Table 1, it can be seen that Example 1-1 in which microwave irradiation is carried out shows a significant decrease in content of the residual organic substances, such as carbon and hydrogen, in the electrolyte to a half or less, as compared to Comparative Example 1-1.

### Test Example 1-4: Change in Color of Electrolyte (Li₆PS₅I)

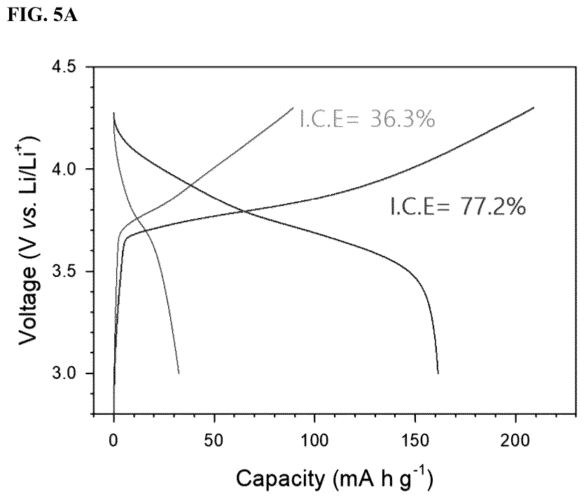

The electrolyte prepared according to each of Example 1-1 and Comparative Examples 1-2 to 1-7 was determined in terms of a change in color of the electrolyte depending on microwave irradiation and heat treatment, by the naked eyes. The results are shown in FIG. 4.

FIG. 4 is a photographic image illustrating a change in color of the electrolyte (Li₆PS₅I) prepared according to each of Example 1-1 and Comparative Examples 1-2 to 1-7 depending on microwave irradiation and heat treatment. Referring to FIG. 4, in the case of Comparative Examples 1-2 to 1-7, it can be seen that the higher the heat treatment temperature, the darker the color of the electrolyte. This suggests that residual organic substances are carbonized and the color is turned into black. On the contrary, in the case of Example 1-1, the electrolyte shows a light brown color, which suggests that no carbonization occurs.

### Test Example 1-5: Evaluation of Charge/Discharge Performance and Rate Characteristics of Solid-State Battery

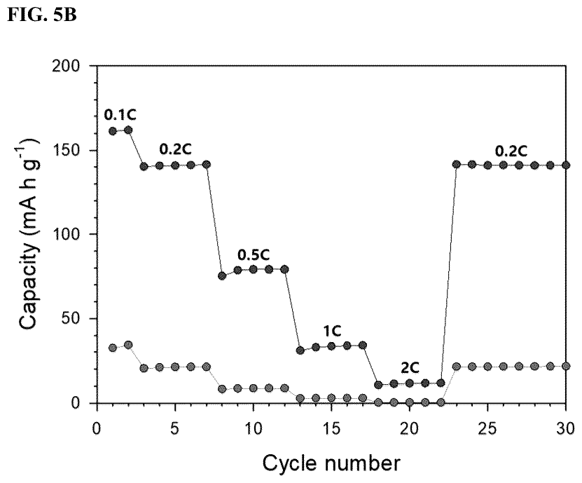

The electrolyte prepared according to each of Example 1-1 and Comparative Example 1-1 was used to obtain a cathode for a solid-state battery by the conventional method. As the cathode, a NCM/Li—In half-cell was manufactured. The cathode was prepared by mixing LiNi_{0.70}Co_{0.15}Mn_{0.15}O₂:electrolyte:Super C at a weight ratio of 70:30:3. The resultant solid-state battery was evaluated in terms of its charge/discharge performance at 0.1 C, 0.2 C, 0.5 C, 1 C and 2 C. The results are. shown in FIG. 5A and FIG. 5B.

FIG. 5A and FIG. 5B are graphs illustrating the charge/discharge performance (FIG. 5A) and rate characteristics (FIG. 5B) of the solid-state battery obtained by using the electrolyte prepared according to each of Example 1-1 (blue line) and Comparative Example 1-1 (black line). Referring to FIG. 5A, it can be seen that Comparative Example 1-1 shows a significantly low initial charge/discharge efficiency (I.C.E) of 36.3%, while Example 1-1 shows an initial charge/discharge efficiency of 77.2%, which is at least 2 times higher as compared to Comparative Example 1-1.

In addition, referring to FIG. 5B, it can be seen that Example 1-1 shows a significantly higher value of rate characteristics at each charge/discharge rate, as compared to Comparative Example 1-1.

### Example 2-1: Preparation of Electrolyte (CS—Li₆PS₅Cl)

First, Li₂S and LiCl as lithium-based precursors were introduced to ethanol at a molar ratio of 2:2 and mixed at room temperature for 3 hours to prepare a lithium-based precursor solution. In addition, Li₂S and P₂S₅ as sulfide-based precursors were introduced to tetrahydrofuran as a solvent at a molar ratio of 3:1 and mixed at room temperature for 12 hours to prepare a sulfide-based precursor solution.

Next, a precursor solution was prepared by introducing the lithium-based precursor powder and the sulfide-based precursor powder mixed at a molar ratio of 1:1.1 and mixed at room temperature for 12 hours to obtain a precursor solution. Then, the precursor solution was dried at 200° C. for 6 hours to obtain a precursor powder. After that, the resultant precursor powder was supported in 165 wt % of carbon black as a carbon composite based on 100 wt % of the precursor powder, and then microwaves were irradiated thereto at an output of 700 W for 5 minutes to obtain an electrolyte having a structure of Li₆PS₅Cl.

### Comparative Example 2-1: Preparation of Electrolyte (F—Li₆PS₅Cl) (Ar)

The same procedure as Example 2-1 was carried out, except that the precursor powder was heat treated in a furnace under argon atmosphere at 550° C. for 6 hours to obtain an electrolyte having a structure of Li₆PS₅Cl.

### Comparative Example 2-2: Preparation of Electrolyte (F—Li₆PS₅Cl) (Vacuum)

The same procedure as Example 2-1 was carried out, except that the precursor powder was heat treated in a furnace at 550° C. for 6 hours to obtain an electrolyte having a structure of Li₆PS₅Cl.

### Comparative Example 2-3: Preparation of Electrolyte (Dried Li₆PS₅Cl)

The same procedure as Example 2-1 was carried out, except that both the step of supporting in a carbon composite and the microwave irradiation step were not carried out, and that the precursor solution was dried at 200° C. for 6 hours to obtain an electrolyte having a structure of Li₆PS₅Cl.

### Test Example 2-1: X-Ray Diffractometry (XRD) of Electrolyte (Li₆PS₅Cl)

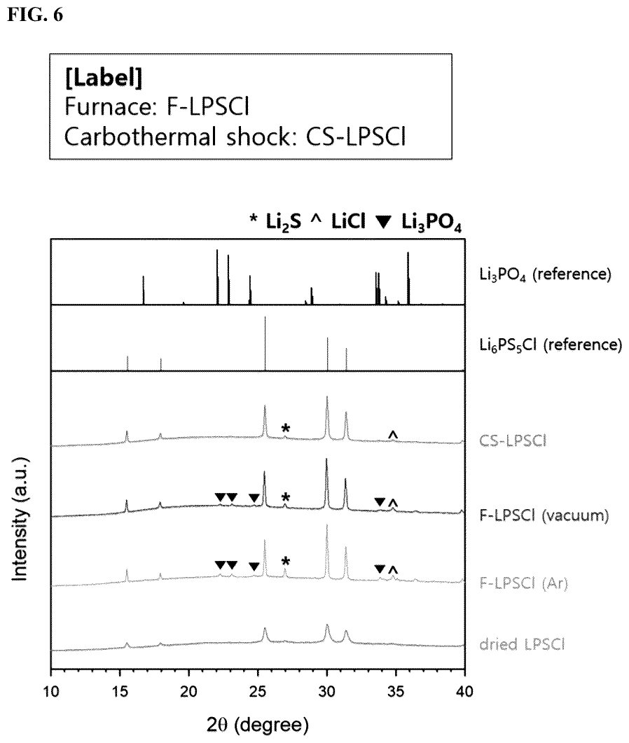

The electrolyte prepared according to each of Example 2-1 and Comparative Examples 2-1 to 2-3 was analyzed by XRD to determine whether residual organic substances were formed or not depending on carbothermal shock and heat treatment. The results are shown in FIG. 6.

FIG. 6 is a graph illustrating the results of XRD of the electrolyte (Li₆PS₅Cl) prepared according to each of Example 2-1 and Comparative Examples 2-1 to 2-3. Referring to FIG. 6, it can be seen that merely a small fraction of Li₂S and LiCl peaks is observed and the same peaks as conventional Li₆PS₅Cl solid electrolyte are shown in Example 2-1 to which a carbothermal shock method is applied by carrying out the steps of supporting in a carbon composite and microwave irradiation without heat treatment.

On the other hand, in the case of Comparative Examples 2-1 and 2-2 in which the precursor powder is heat treated under argon or vacuum, many Li₂S, LiCl and Li₃SPO₄ peaks are observed due to the long-time exposure at high temperature.

In addition, in the case of Comparative Example 2-3 in which the precursor solution is dried, no residual organic substance peaks are observed due to the low crystallinity, but it can be seen that Li₆PS₅Cl solid electrolyte shows poor crystallinity due to the significantly weak peak intensity.

### Test Example 2-2: Electroconductivity Analysis of Electrolyte (Li₆PS₅Cl)

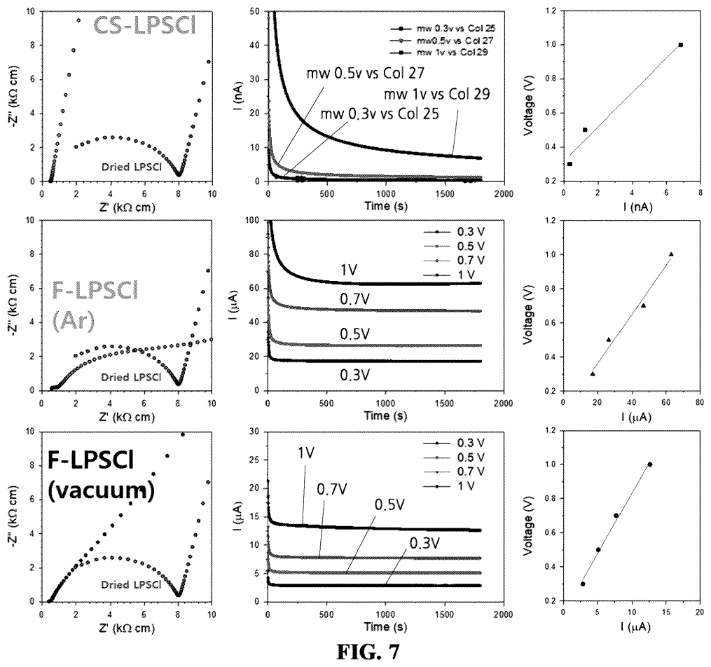

The electrolyte prepared according to each of Example 2-1 and Comparative Examples 2-1 and 2-2 was analyzed through the Nyquist plot, direct current (DC) polarization curve and linear regression at 30° C. in order to determine the electroconductivity. The results are shown in FIG. 7.

FIG. 7 shows the Nyquist plot, DC polarization curve and linear regression graph of the electrolyte (Li₆PS₅Cl) prepared according to each of Example 2-1 and Comparative Examples 2-1 and 2-2. Referring to FIG. 7, it can be seen that Example 2-1 in which both the step of supporting in a carbon composite and the microwave irradiation step are carried out shows low electroconductivity despite high ion conductivity. On the contrary, Comparative Examples 2-1 and 2-2 show high electroconductivity.

### Test Example 2-3: Analysis of Ion Conductivity and Electroconductivity of Electrolyte (Li₆PS₅Cl)

The electrolyte prepared according to each of Example 2-1 and Comparative Examples 2-1 to 2-3 was determined in terms of lithium-ion conductivity and electroconductivity at 30° C. depending on carbothermal shock and heat treatment. The results are shown in the following Table 2.

TABLE 2

| | Lithium-ion | |
|---|---|---|
| | conductivity | Electroconductivity |
| | (mS/cm) | (S/cm) |
| Comp. Ex. 2-1 (F-LPSCI) (Ar) | 1.1 | 1.7 × 10⁻⁵ |
| Comp. Ex. 2-2 (F-LPSCI) (Vacuum) | 1.8 | 2.8 × 10⁻⁶ |
| Comp. Ex. 2-3 (Dried LPSCI) | 0.12 | 9.6 × 10⁻¹⁰ |
| Ex. 2-1 (CS-LPSCI) | 2.5 | 2.4 × 10⁻⁹ |

Referring to Table 2, it can be seen that Example 2-1 shows a significantly low value of electroconductivity as well as high lithium-ion conductivity, since the crystallinity is improved and carbonization is inhibited as compared to Comparative Examples 2-1 to 2-3.

On the contrary, it can be seen that Comparative Examples 2-1 and 2-2 show higher electroconductivity and relatively lower lithium-ion conductivity as compared to Example 2-1, since the residual organic substances are carbonized. It can be also seen that Comparative Example 2-3 in which no heat treatment is carried out shows the lowest lithium-ion conductivity and electroconductivity.

### Test Example 2-4: Change in Color of Electrolyte (Li₆PS₅Cl)

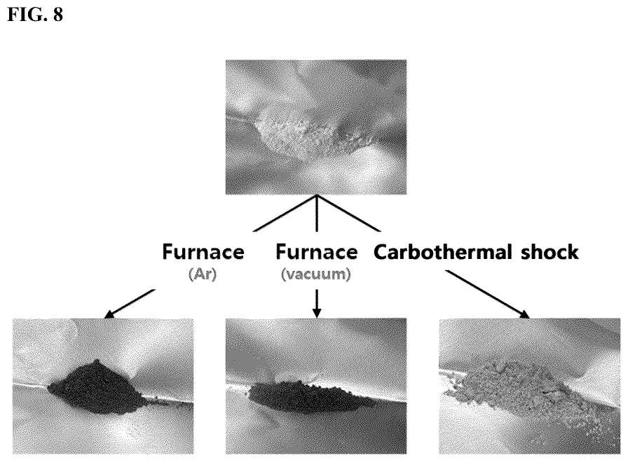

The electrolyte prepared according to each of Example 2-1 and Comparative Examples 2-1 and 2-2 was determined in terms of a change in color of the electrolyte depending on carbothermal shock and heat treatment, by the naked eyes. The results are shown in FIG. 8.

FIG. 8 is a photographic image illustrating a change in color of the electrolyte (Li₆PS₅Cl) prepared according to Example 2-1 as compared to Comparative Examples 2-1 and 2-2. Referring to FIG. 8, in the case of Comparative Examples 2-1 and 2-2 in which heat treatment is carried out under argon or vacuum, it can be seen that residual organic substances are carbonized and the color is turned into black due to the long-term exposure at high temperature as the heat treatment is carried out under argon or vacuum, thereby providing a carbonized electrolyte. On the contrary, in the case of Example 2-1, it can be seen that the electrolyte shows a light brown color, since the carbon composite functions as a heat source and the heat treatment is carried out at high temperature for a short time through the microwave irradiation, which suggests that no carbonization occurs.

### Test Example 2-5: Evaluation of Charge/Discharge Performance and Rate Characteristics of Solid-State Battery

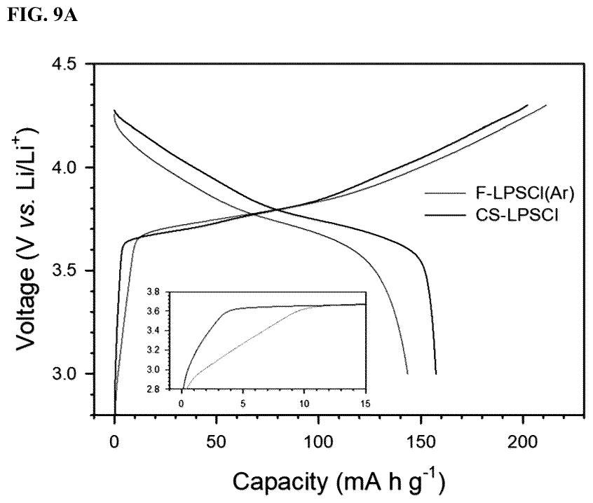

The electrolyte prepared according to each of Example 2-1 and Comparative Example 2-1 was used to obtain a cathode for a solid-state battery by the conventional method. As the cathode, a NCM/Li—In half-cell was manufactured. The cathode was prepared by mixing NCM711@LNO: electrolyte (LPSCL): Super C at a weight ratio of 70:30:3. The resultant solid-state battery was evaluated in terms of its charge/discharge performance under the conditions of 30° C., 3.0-4.3 V and a loading amount of 7.68 mg/cm². The results are shown in FIG. 9A and FIG. 9B.

FIG. 9A and FIG. 9B are graphs illustrating the charge/discharge performance (FIG. 9A) and rate characteristics (FIG. 9B) of the solid-state battery obtained by using the electrolyte prepared according to each of Example 2-1 (blue line) and Comparative Example 2-1 (light green line). Referring to portion FIG. 9A, it can be seen that Comparative Example 2-1 shows a significantly low initial charge/discharge efficiency (I.C.E) of 67.9%, while Example 2-1 shows a high initial charge/discharge efficiency of 77.8%.

In addition, referring to FIG. 9B, it can be seen that Example 2-1 shows a significantly higher value of rate characteristics at each charge/discharge rate, as compared to Comparative Example 2-1.

### Test Example 2-6: Elemental Analysis of Solid-State Battery

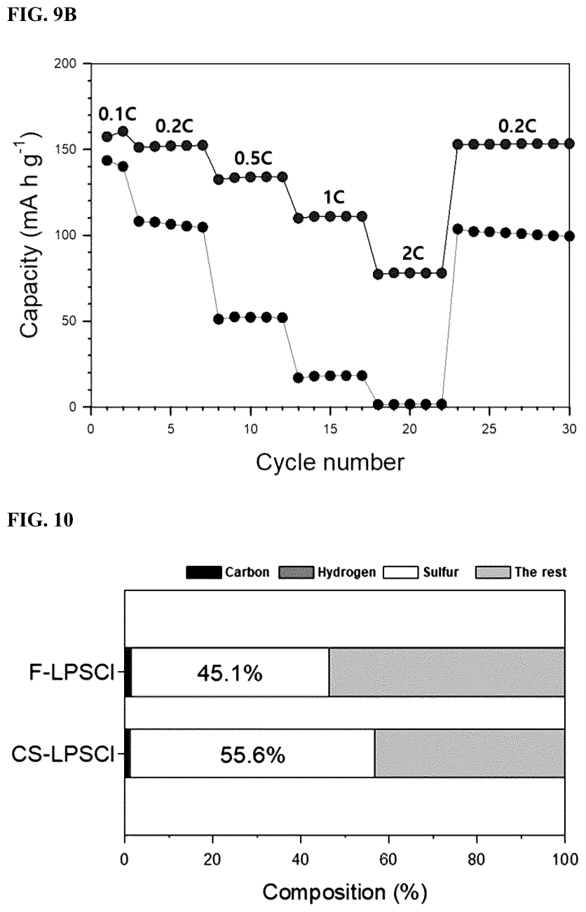

The electrolyte prepared according to each of Example 2-1 and Comparative Example 2-1 was used to obtain a solid-state battery, NCM/Li—In half-cell, in the same manner as Test Example 2-4. Then, elemental analysis was carried out by using the conventional method. The results are shown in FIG. 10 and Table 3.

FIG. 10 is a graph illustrating the results of elemental analysis of the solid state battery using the electrolyte prepared according to each of Example 2-1 and Comparative Example 2-1.

TABLE 3

| | Carbon | Hydrogen | Sulfur |
|---|---|---|---|
| Comp. Ex. 2-1 (F-LPSCI) | 0.8566 wt % | 0.5082 wt % | 45.1 wt % |
| Ex. 2-1 (CS-LPSCI) | 0.7301 wt % | 0.4925 wt % | 55.6 wt % |

It can be seen from the results of FIG. 10 and Table 3 that Example 2-1 to which the solid electrolyte heat-treated by using carbothermal shock is applied shows a relatively smaller loss in sulfur as compared to Comparative Example 2-1.

### Test Example 2-7: Raman Spectroscopy Analysis of Solid-State Battery

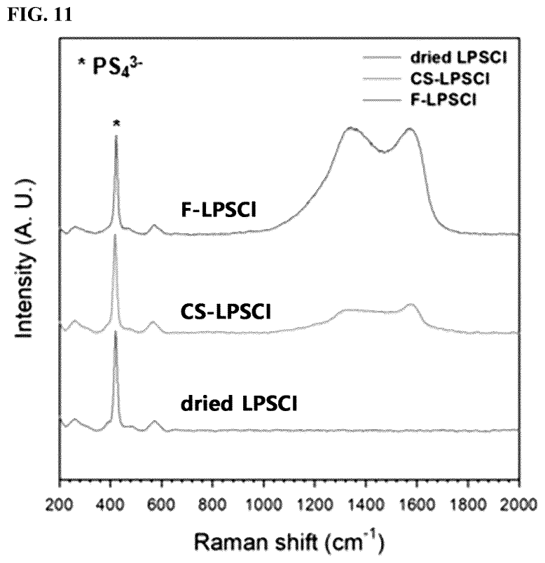

The electrolyte prepared according to each of Example 2-1 and Comparative Example 2-1 was used to obtain a solid-state battery, NCM/Li—In half-cell, in the same manner as Test Example 2-4. Then, Raman spectroscopy was carried out to analyze the degree of carbonization. The results are shown in FIG. 11 and Table 4. For the purpose of comparison, an electrolyte having a structure of LPSCl was further tested.

FIG. 11 is a graph illustrating the results of Raman analysis of the solid state battery using the electrolyte prepared according to each of Example 2-1 and Comparative Example 2-1.

TABLE 4

| | I_{D}/I_{P} | I_{G}/I_{P} |
|---|---|---|
| Comp. Ex. 2-1 (F-LPSCI) | 1.018 | 1.017 |
| Ex. 2-1 (CS-LPSCI) | 0.616 | 0.643 |

I_{P}: PS₄³⁻ peak intensity (at around 420 cm⁻¹)
I_{D}: D- band intensity (at around 1350 cm⁻¹)
I_{G}: G- band intensity (at around 1580 cm⁻¹)

It can be seen from the results of FIG. 11 and Table 4 that Comparative Example 2-1 shows a high value of I_{D}/I_{P} intensity and I_{G}/I_{P} intensity due to the carbonization of electrolyte, which suggests that carbonization occurs to a high degree.

On the contrary, it can be seen that Example 2-1 shows a significantly low value of I_{D}/I_{P} intensity and I_{G}/I_{P} intensity, which suggests that carbonization is inhibited.

### Test Example 2-8: ³¹P NMR Analysis of Solid-State Battery

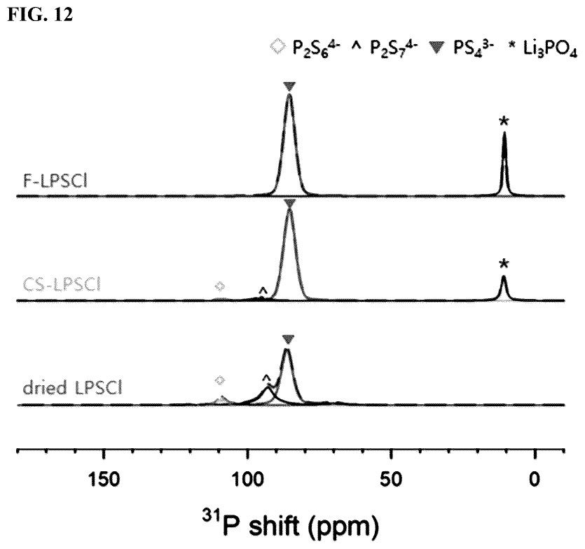

The electrolyte prepared according to each of Example 2-1 and Comparative Example 2-1 was used to obtain a solid-state battery, NCM/Li—In half-cell, in the same manner as Test Example 2-4. Then, nuclear magnetic resonance (NMR) analysis was carried out to determine the impurities. The results are shown in FIG. 12. For the purpose of comparison, an electrolyte having a dried LPSCl structure was further tested.

FIG. 12 is a graph illustrating the results of ³¹P NMR analysis of the solid state battery using the electrolyte prepared according to each of Example 2-1 and Comparative Example 2-1. Referring to FIG. 12, it can be seen that in the case of Example 2-1, the electrolyte heat-treated by carbothermal shock shows a significantly low ratio (0.265) of Li₃PO₄ peak intensity to PS₄³⁻ (85 ppm) peak intensity, which suggests that a small amount of LisPO₄ impurity is formed.

On the contrary, in the case of Comparative Example 2-1, the ratio of LisPO₄ peak intensity to PS₄³⁻ (85 ppm) peak intensity is 0.699, which is a relatively higher value as compared to Example 2-1. This suggests that a large amount of LisPO₄ impurity is formed.

As a result, the electrolyte prepared according to Example 2-1 shows a small loss in sulfur by virtue of the heat treatment using carbothermal shock, and the ratio of D-band and that of G-band suggest that carbonization is inhibited. In addition, the electrolyte shows a significantly low peak of LisPO₄ impurity, as determined through ³¹P NMR analysis.

What is claimed is:

1. A method for preparing an electrolyte, comprising the steps of:
(A) preparing a precursor solution containing a lithium-based precursor, and a sulfide-based or oxide-based precursor;
(B) drying the precursor solution to obtain a precursor powder; and
(C) irradiating microwaves to the precursor powder to obtain an electrolyte represented by the following Chemical Formula 1:
LiₓM_{y}Q_{z}Xₐ [Chemical Formula 1]
wherein 4≤x≤6, 0.5≤y≤1.5, 3≤z≤9, 0≤a≤2, and M represents at least one selected from the group consisting of P, Fe, Mo, Sn, Ge, Al, Sb, Ga, Ti, B and Si;
Q represents S, O or a combination thereof; and
X represents at least one selected from the group consisting of Cl, Br and I.

2. The method for preparing an electrolyte according to claim 1, wherein the microwave irradiation in step (C) is carried out directly to the precursor powder, while not supporting the precursor powder obtained from step (B) in carbon or a carbon composite.

3. The method for preparing an electrolyte according to claim 2, wherein
the lithium-based precursor is selected from the group consisting of LiCl, LiBr, LiI, Li₂S and a combination of two or more of them,
the sulfide-based precursor is selected from the group consisting of Li₂S, P₂S₅, FeS, MoS₂, SnS₂, SnS, GeS₂, GeS, Al₂S₃, Sb₂S₃, Ga₂S₃ TiS₂, B₂S₃, SiS₂ and a combination of two or more of them,
the oxide-based precursor is selected from the group consisting of Li₂O, P₂O₅, ZnO, SnO₂, Sb₂O₃, Sb₂O₅, Fe₂O₃, Fe₂O₄, Bi₂O₃, In₂O₃ and a combination of two or more of them,
the precursor solution comprises the lithium-based precursor and the sulfide-based or oxide-based precursor mixed at a molar ratio of 1:0.3-1:2.5; and
the microwave irradiation in the step of preparing an electrolyte is carried out at an output of 500-900 W for 10-30 minutes.

4. The method for preparing an electrolyte according to claim 2, wherein X represents I.

5. The method for preparing an electrolyte according to claim 2, wherein
the lithium-based precursor is a mixture containing Li₂S and LiI mixed at a molar ratio of 1:1-1:3,
the sulfide-based precursor is a mixture containing Li₂S and P₂S₅ mixed at a molar ratio of 2:1-4:1,
the precursor solution comprises the lithium-based precursor and the sulfide-based precursor mixed at a molar ratio of 1:0.9-1:1.3,
the step of preparing a precursor solution is carried out by mixing the precursors at room temperature for 11-13 hours,
the drying is carried out at 190-210° C. for 6-12 hours in the step of preparing a precursor powder,
microwaves are irradiated at an output of 650-750 W for 14-17 minutes in the step of preparing an electrolyte,
the electrolyte is Li₆PS₅I, and
the electrolyte shows a lithium-ion conductivity of 6.0×10⁻⁶ to 1.0×10⁻⁵ S/cm at 30° C.

6. The method for preparing an electrolyte according to claim 1, wherein the microwave irradiation in step (C) is carried out after supporting the precursor powder obtained from step (B) in carbon or a carbon composite.

7. The method for preparing an electrolyte according to claim 6, wherein
the lithium-based precursor is selected from the group consisting of LiCl, LiBr, LiI, Li₂S and a combination of two or more of them,
the sulfide-based precursor is selected from the group consisting of Li₂S, P₂S₅, FeS, MoS₂, SnS₂, SnS, GeS₂, GeS, Al₂S₃, Sb₂S₃, Ga₂S₃ TiS₂, B₂S₃, SiS₂ and a combination of two or more of them,
the oxide-based precursor is selected from the group consisting of Li₂O, P₂O₅, ZnO, SnO₂, Sb₂O₃, Sb₂O₅, Fe₂O₃, Fe₂O₄, Bi₂O₃, In₂O₃ and a combination of two or more of them,
the precursor solution comprises the lithium-based precursor and the sulfide-based or oxide-based precursor mixed at a molar ratio of 1:0.3-1:2.5; and
the microwave irradiation in the step of preparing an electrolyte is carried out at an output of 50-1,000 W for 30 seconds to 10 minutes.

8. The method for preparing an electrolyte according to claim 6, wherein X represents Cl.

9. The method for preparing an electrolyte according to claim 6, wherein
the carbon or carbon composite is selected from the group consisting of carbon black, graphite, SiC and a combination of two or more of them, and
100 parts by weight of the precursor powder is supported in 100-220 parts by weight of the carbon or carbon composite.

10. The method for preparing an electrolyte according to claim 6, wherein
the lithium-based precursor is a mixture containing Li₂S and LiCl or LiI mixed at a molar ratio of 1:1-1:3,
the sulfide-based precursor is a mixture containing Li₂S and P₂S₅ mixed at a molar ratio of 2:1-4:1,
the step of preparing a precursor solution is carried out by mixing the precursors at room temperature for 11-13 hours,
the precursor powder comprises the lithium-based precursor and the sulfide-based precursor mixed at a molar ratio of 1:0.7-1:1.5,
the drying is carried out at 190-210° C. for 6-12 hours in the step of preparing a precursor powder,
the step of preparing an electrolyte is carried out by supporting the precursor powder in carbon or a carbon composite and irradiating microwaves thereto,
the carbon composite is carbon black,
the carbon or carbon composite is supported in an amount of 155-175 wt % based on 100 wt % of the precursor powder,
the microwave irradiation is carried out at an output of 100-700 W for 2-7 minutes,
the electrolyte is Li₆PS₅Cl or Li₆PS₅I,
the electrolyte shows a lithium-ion conductivity of 2.0-4 S/cm and an electroconductivity of 1×10⁻⁹ to 2×10⁻⁷ S/cm at 30° C.,
the content of sulfur in the electrolyte is 53-62 wt % based on 100 wt % of the electrolyte,
the ratio (I_{D}/I_{P}) of D-band intensity (I_{D}) to PS₄³⁻ peak intensity is 0.5-0.7, and the ratio (I_{G}/I_{P}) of G-band intensity (I_{G}) to PS₄³⁻ peak intensity is 0.4-0.8, according to the results of Raman analysis of the electrolyte, and
the electrolyte shows a ratio of LisPO₄ impurity peak intensity to PS₄³⁻ peak intensity of 0.2-0.4, as determined by ³¹P NMR analysis.

11. The method for preparing an electrolyte according to claim 10, wherein
the lithium-based precursor is a mixture containing Li₂S and LiI mixed at a molar ratio of 1:1-1:2,
the sulfide-based precursor is a mixture containing Li₂S and P₂S₅ mixed at a molar ratio of 2.5:1-3.5:1,
the precursor powder comprises the lithium-based precursor and the sulfide-based precursor mixed at a molar ratio of 1:0.9-1:1.3,
the microwave irradiation is carried out at an output of 180-700 W for 3-5 minutes,
the electrolyte is Li₆PS₅Cl,
the electrolyte shows a lithium-ion conductivity of 2.1-3.2 S/cm and an electroconductivity of 1×10⁻⁹ to 3×10⁻⁹ S/cm at 30° C.,
the content of sulfur in the electrolyte is 55-60 wt % based on 100 wt % of the electrolyte, and
the electrolyte shows a ratio of LisPO₄ impurity peak intensity to PS₄³⁻ peak intensity of 0.2-0.3, as determined by ³¹P NMR analysis.
